(19) United States
(12) Patent Application Publication
(10) Pub. No.: US 2026/0302738 A1
(43) Pub. Date: Oct. 1, 2026

(54) STRIPPING PLIERS HAVING TWO PLIER JAWS

(71) Applicant: Rennsteig Werkzeuge GmbH, Steinbach-Hallenberg (DE)

(72) Inventors: Georg HOLLAND-MORITZ, Steinbach-Hallenberg (DE); Marcel BONSS, Schmalkalden (DE); Marko ENDTER, Steinbach-Hallenberg (DE); Michael BRÜCKNER, Steinbach-Hallenberg (DE)

(73) Assignee: Rennsteig Werkzeuge GmbH, Steinbach-Hallenberg (DE)

(21) Appl. No.: 19/477,955

(22) PCT Filed: Apr. 23, 2024
(86) PCT No.: PCT/EP2024/061096

§ 371 Date: Oct. 23, 2025

(30) Foreign Application Priority Data
Apr. 25, 2023 (DE) 10 2023 110 577.9

(51) Int. Cl. H02G 1/12

(52) U.S. Cl. CPC H02G 1/1212

(57) ABSTRACT

Wire stripping pliers have two pliers jaws, two outer clamping jaws, two inner cutting jaws, and two handle parts, wherein the cutting jaws can be displaced from a starting position into an end position in the course of squeezing the handle parts. The cutting jaws each have a blade with a cutting edge, and the cutting edges, in a defined position in which the cutting jaws are brought towards one another, being at a specific distance from each other, and in a position to be regarded as a basic position, the distance is adjustable via an adjusting screw. The adjusting screw can be connected to an adjusting wheel which can be aligned with a marking fixed to one of the pliers jaws for the basic position.

### CROSS REFERENCE TO RELATED APPLICATIONS

This application is the National Stage of PCT/EP2024/061096 filed on Apr. 23, 2024, which claims priority under 35 U.S.C. § 119 of German Application No. 10 2023 110 577.9 filed on Apr. 25, 2023, the disclosure of which is incorporated by reference. The international application under PCT article 21(2) was not published in English.

### FIELD OF TECHNOLOGY

The invention relates to wire stripping pliers with two pliers jaws, two outer clamping jaws, two inner cutting jaws, and two handle parts, wherein the cutting jaws can be displaced from a starting position into an end position in the course of squeezing the handle parts, and wherein the cutting jaws each have a blade with a cutting edge, the cutting edges being, in a defined position in which the cutting jaws are brought towards one another, at a specific distance from each other, and wherein, in a position to be regarded as a basic position, the distance is adjustable via an adjusting screw.

The invention also relates to a method for setting a cutting-edge spacing on wire stripping pliers having two pliers jaws, two outer clamping jaws, two inner cutting jaws, and two handle parts, wherein the cutting jaws can be displaced from a starting position into an end position in the course of squeezing the handle parts, and wherein the cutting jaws each have a blade with a cutting edge, the cutting edges being, in a defined position in which the cutting jaws are brought towards one another, at a specific distance from each other, and wherein, in a position to be regarded as a basic position, the distance is adjustable via an adjusting screw.

### STATE OF THE ART

Wire stripping pliers of the type in question are known. These serve to strip electrical cables. In this context, so-called automatic wire stripping pliers have become known, which, in one working step, cut into the insulation and subsequently, in the course of further squeezing of the handle parts, at least partially pull it off the conductor. The cutting depth of the cutting jaws must usually be adjusted to the thickness of the insulation layer in order to expose the electrical conductor without damage.

Wire stripping pliers of the type in question are known, for example, from DE 44 20 006 C2. These wire stripping pliers are provided with an adjusting screw, by means of which a lever supporting one of the two cutting jaws can be acted upon to adjust the distance between the cutting edges relative to each other. The adjusting screw has a formation that can be used for adjustment.

From CH 482 327 A there is known a knob for adjustment which is formed in one piece with a screw. In addition, U.S. Pat. No. 2,125,005 A and US 2021/006 049 A are to be mentioned as part of the prior art.

Such wire stripping pliers are also known, for example, from U.S. Pat. No. 3,596,541 A, which pliers have an adjusting screw that can act directly on one of the cutting jaws to adjust the distance between the cutting edges. The adjusting screw can be detented in 90° steps, viewed in the direction of rotation of the adjusting screw.

The cited prior art discloses, for setting a cutting-edge spacing on the wire stripping pliers, setting solely with the adjusting screw.

### SUMMARY OF THE INVENTION

Starting from prior art as given by DE 44 20 006 A1, the invention has the object of further improving wire stripping pliers of the type in question and a method for setting a cutting-edge spacing on such wire stripping pliers.

This object is solved, firstly, by a wire stripping pliers having two pliers jaws, two outer clamping jaws, two inner cutting jaws, and two handle parts, wherein the cutting jaws can be displaced from a starting position into an end position in the course of squeezing the handle parts. The cutting jaws each have a blade with a cutting edge, and the cutting edges, in a defined position in which the cutting jaws are brought towards one another, being at a specific distance from each other, and in a position to be regarded as a basic position, the distance is adjustable via an adjusting screw, wherein it is arranged that the adjusting screw is connected to an adjusting wheel which can be aligned with a marking fixed to one of the pliers jaws for the basic position, A fixing of the position of the adjusting wheel relative to the adjusting screw is made unchangeably, the fixing being achieved by a locking screw passing through the adjusting wheel and received in a thread of the adjusting screw, or by a positive engagement of the adjusting wheel with the adjusting screw, wherein a receptacle of the adjusting screw has a polygonal cross-section for receiving a polygonal drive projection of the adjusting wheel, and wherein the positive engagement is finally secured by a locking screw which passes through a central bore of the adjusting wheel and engages in a thread of the adjusting screw.

This object is further solved by a process in which, the adjusting screw is connectable to the adjusting wheel and the adjusting wheel is alignable with a marking fixed to one of the pliers jaws for the basic position, that for setting the basic setting only the adjusting screw is used, and only after this basic alignment of the cutting jaws the adjusting screw is provided with the adjusting wheel to enable a further distance adjustment to be carried out from the basic position.

Via the adjusting wheel, from the basic position taken via the adjusting screw, a (further) adjustment of the cutting-edge distance by the user is enabled. For this purpose, the adjusting screw—by means of which preferably solely, initially, for example by the manufacturer, the basic setting can be made—is to be provided with the adjusting wheel. Preferably, solely via this adjusting wheel, the user is given the possibility, in particular without tools, to make a further (fine) adjustment of the cutting-edge distance.

For this purpose, the adjusting wheel can be provided with an easy-to-handle section, for example with a circumferential knurling at the rim.

To set the basic position, only the adjusting screw is used. Only after this basic alignment of the cutting jaws, in the preferred embodiment, is the adjusting screw provided with the adjusting wheel to enable a further distance adjustment to be carried out from the basic position.

Via the adjusting wheel, even after a further distance adjustment, the basic setting is easily found again by the user. For this purpose, a marking formed preferably on a fixed part of the wire stripping pliers, for example on a pliers jaw carrying the adjusting screw, is provided, at which a counter-marking on the adjusting wheel can be aligned.

Such wire stripping pliers are usually used to strip electrical cables with different conductor cross-sections, for example of 0.75 mm², 1 mm², 1.5 mm², 2.5 mm², 4 mm², or 10 mm². Depending on the distance between the outer clamping jaws when gripping the cable to be stripped, a cutting depth of the cutting edges and thus the smallest possible distance of the cutting edges, adapted to the conductor cross-section, is automatically set. Accordingly, in a known manner there results an automatic adjustment of the cutting-edge distance in dependence on the overall outer cross-section of the cable.

Particularly with cables of smaller cross-section, however, readjustment of the cutting depth or of the cutting-edge distance may be necessary. In particular, due to unfavorable temperature effects, without such readjustment damage to the conductor to be exposed may occur.

The fixing of the position of the adjusting wheel relative to the adjusting screw is provided unchangeably. It can be made unchangeably, for example by the manufacturer. This is by a force-fit and/or positive engagement connection of adjusting wheel and adjusting screw after carrying out the basic alignment by means of the adjusting screw.

The fixing can be achieved, for example, by a locking screw which passes through the adjusting wheel and is received in a thread of the adjusting screw. The locking screw can be self-locking in order thereby to ensure fixing of the adjusting wheel and the adjusting screw relative to each other. Adhesive bonding of the locking screw in the receiving thread can also be provided for this purpose.

The fixing by the positive engagement of the adjusting wheel with the adjusting screw can be in combination with the fixing by means of the locking screw.

Alternatively or in combination with fixing by means of a locking screw, the fixing can also be achieved by a positive engagement of the adjusting wheel with the adjusting screw. For this purpose, the adjusting screw can, for example, have a drive opening which can further, for example, also serve to temporarily receive a correspondingly designed tool for adjusting the basic position. Such a receptacle may, for example, have a polygonal cross-section for receiving a polygonal tool, or, after adjustment of the basic position and arrangement of the adjusting wheel, for receiving a polygonal drive projection of the adjusting wheel.

The adjusting wheel can interact with a detent device fixed to the pliers jaw. Such a detent device can usually be overridden in the course of a user's action on the adjusting wheel upon initiating rotation of the wheel.

The detent device can act, for example, alone or at least in the basic position of the adjusting wheel. This also provides a haptic signal to the user as soon as the basic position is reached.

The detent device may, in one embodiment, have a protruding, springable detent projection which engages in a detent recess of the adjusting wheel. The detent projection can be formed on a separate spring part which can be fastened to the associated pliers jaw for interaction with the adjusting wheel. Furthermore, such a spring part can be a plastic injection-molded part, having an elastically resilient section to form the detent projection.

Viewed in a direction of rotation of the adjusting wheel, several detent recesses can be formed on the adjusting wheel. These can, as preferred, be provided at equal angular intervals from each other in the direction of rotation. Furthermore, for example, an angle of more than 5° up to 45° may result between two detent recesses following one another in the direction of rotation, for example approximately 10°, 15°, or 30°.

The detent recesses can be formed at different height levels with respect to the direction of rotation. Thus, starting from the basic position, in one rotation direction of the adjusting wheel there can be a continuous increase in the height level of the subsequent detent recesses viewed in the direction of the axis of rotation, and in the opposite rotation direction, a continuous decrease in the height level of the subsequent detent recesses in this direction. The height level is defined by the distance, viewed in the direction of the axis of rotation, between the bottom of the detent recess and a transverse plane to the axis of rotation.

The increase or decrease of the height level can be accompanied by an increase or decrease in the spring force of the detent device to be overcome. For example—starting from the basic position—a plus rotation direction can cause an increase in the cutting-edge spacing, accompanied by a decreasing height level of the corresponding detent recesses and a corresponding reduction in the spring force of the detent device. A reverse rotation in the minus rotation direction leads, for example, to a reduction in the cutting-edge spacing. The resulting reduction in the height level of the detent recesses and the associated increase in the spring force of the detent device gives the executing user a haptic signal that a critical reduction in spacing is being made which may possibly result in damage to the electrical conductor to be exposed.

The rotatability of the adjusting wheel can be limited to a specific rotation angle range. Preferably, the further preferred basic alignment lies centrally in the possible rotation angle range.

In a preferred embodiment, the rotation angle range is less than 360°. Thus, a rotation angle range of, for example, 90° or more, further, for example up to 180° or 270°, may be provided. Furthermore, a rotation angle range of, for example, approximately 210° or 225° may be provided.

Over the limited rotation angle range, ten or more, for example up to twenty or more, further for example fifteen detent recesses can be provided, preferably evenly spaced from each other.

The limitation of rotatability can be achieved by positive engagement between the adjusting wheel and the associated pliers jaw, furthermore, for example, by a projection formed on the underside of the adjusting wheel which engages in a longitudinally limited groove in the pliers jaw.

Alternatively, the detent recesses can also be formed, for example, on the pliers jaw, and the spring-loaded detent projection that interacts therewith can be on the adjusting wheel. To limit rotatability, a projection can also be formed on the pliers jaw which engages in a longitudinally limited groove of the adjusting wheel.

The action of the adjusting screw on the associated cutting jaw can be direct. Alternatively, only indirect action is provided, for example in a design in which one or both cutting jaws, in a direction of travel of the cutting jaws towards each other, can be acted upon on the outside of the cutting jaw by a sliding shoe.

In the case of such a design, the adjusting screw can act indirectly on the associated cutting jaw via the sliding shoe.

The ranges or value ranges or multiple ranges specified above and below also include, with regard to disclosure, all intermediate values, in particular in 1/10 steps of the respective dimension, optionally also dimensionless. For example, the specification 90 to 270° also includes the disclosure of 90.1 to 270°, 90 to 269.9°, 90.1 to 269.9°, etc. This disclosure can serve, on the one hand, to delimit a stated range boundary from below and/or above, alternatively or additionally, to disclose one or more singular values from a respectively stated range.

### BRIEF DESCRIPTION OF THE DRAWINGS

The invention is explained below with reference to the accompanying drawing, which however represents only one exemplary embodiment. The drawing shows:

FIG. 1 a wire stripping pliers in a perspective view, relating to a pliers mouth closed position;

FIG. 2 the longitudinal section along line II-II in FIG. 1, relating to a pliers mouth open position;

FIG. 3 a perspective bottom view of the wire stripping pliers, with an adjusting device in exploded perspective;

FIG. 4 a perspective sectional view through section plane IV in FIG. 3;

FIG. 5 the section according to FIG. 4, after insertion of an adjusting screw and setting of a basic position of the adjusting screw;

FIG. 6 the view according to arrow VI in FIG. 5;

FIG. 7 a sectional view corresponding to FIG. 5 after arrangement of an adjusting wheel;

FIG. 8 the view according to arrow VIII in FIG. 7;

FIG. 9 a sectional view according to FIG. 7, with a cable with a large cross-section clamped between clamping jaws;

FIG. 10 a representation corresponding to FIG. 2 in the course of the stripping operation of a cable according to FIG. 9;

FIG. 11 a representation following FIG. 10 after completion of the stripping operation;

FIG. 12 a representation corresponding to FIG. 9 with a clamped cable of small cross-section;

FIG. 13 a representation corresponding to FIG. 2 in the course of the stripping operation of a cable according to FIG. 12;

FIG. 14 a representation following FIG. 13 after completion of the stripping operation;

FIG. 15 the adjusting wheel in a single perspective view;

FIG. 16 the view of the adjusting wheel according to arrow XVI in FIG. 15;

FIG. 17 the top view of the adjusting wheel according to arrow XVII in FIG. 16;

FIG. 18 the bottom view of the adjusting wheel according to arrow XVIII in FIG. 16;

FIG. 19 the section along line XIX-XIX in FIG. 17;

FIG. 20 the enlargement of area XX in FIG. 19;

FIG. 21 the enlarged section along line XXI-XXI in FIG. 17;

FIG. 22 the enlargement of area XXII in FIG. 19;

FIG. 23 the adjusting screw in a single perspective view;

FIG. 24 the adjusting screw in side view;

FIG. 25 a detent device with a detent projection in a single perspective view;

FIG. 26 the side view according to arrow XXVI in FIG. 25 of the detent device;

FIG. 27 the view according to arrow XXVII in FIG. 26.

### DESCRIPTION OF THE EMBODIMENTS

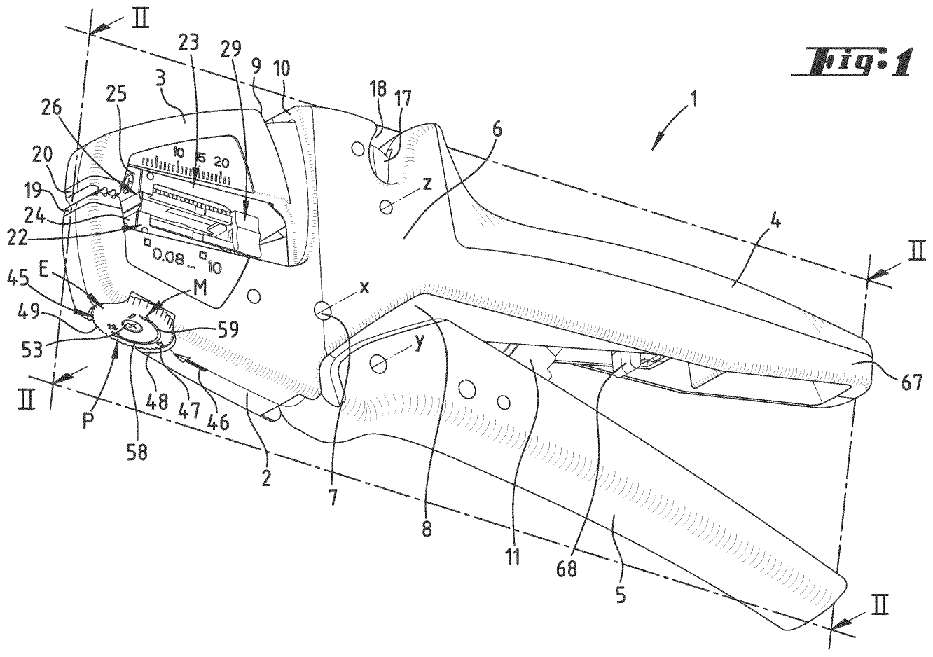

Shown and described first, with reference to FIG. 1, are wire stripping pliers 1 with two pliers jaws 2, 3 and two handle parts 4, 5. The pliers jaws 2 and 3 delimit a pliers mouth ZM.

The pliers jaw 2, referred to hereinafter as fixed, is connected directly and firmly to the handle part 4 via a cheek area 6.

In the cheek area 6, the wire stripping pliers 1 provide a bearing for a pivot axis 7 with a geometric axis x, about which the pliers jaw 3, referred to hereinafter as movable, is rotatably mounted.

The mounting of the movable pliers jaw 3 on the pivot axis 7 is provided in the area of a shoulder area 8 of the movable pliers jaw 3 which, in the direction of extension of the axis x in projection to the cheek area 6 of the fixed pliers jaw 2, extends.

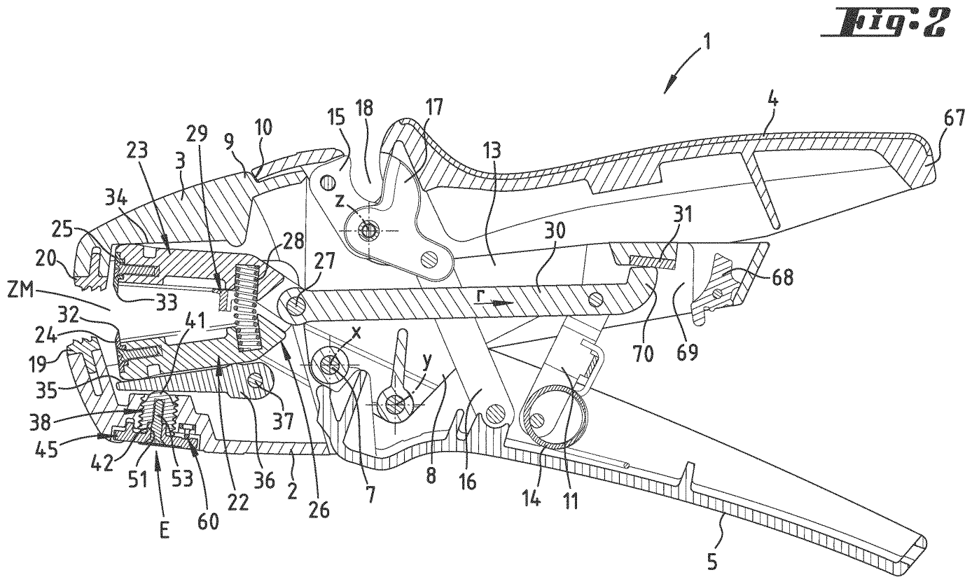

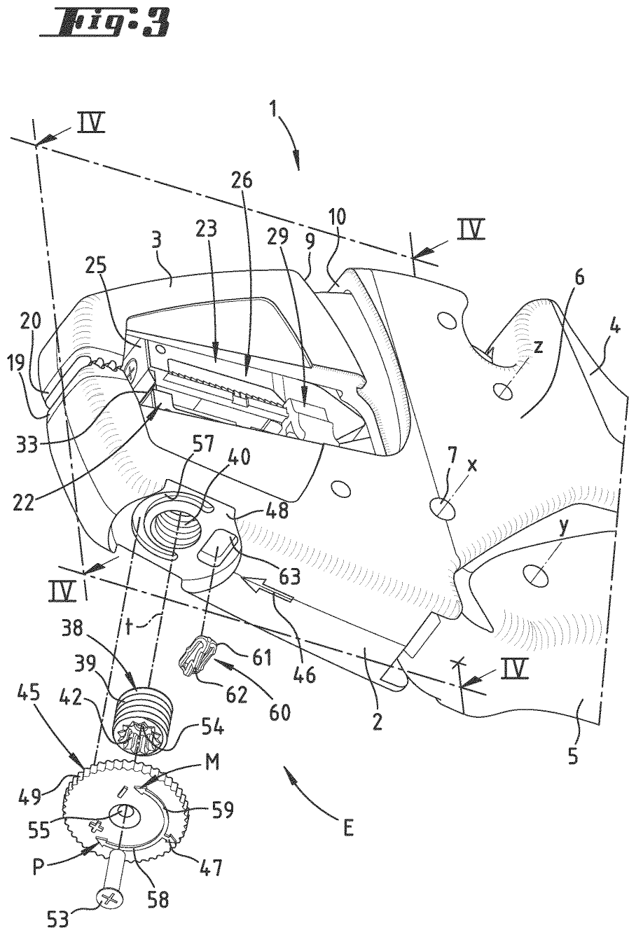

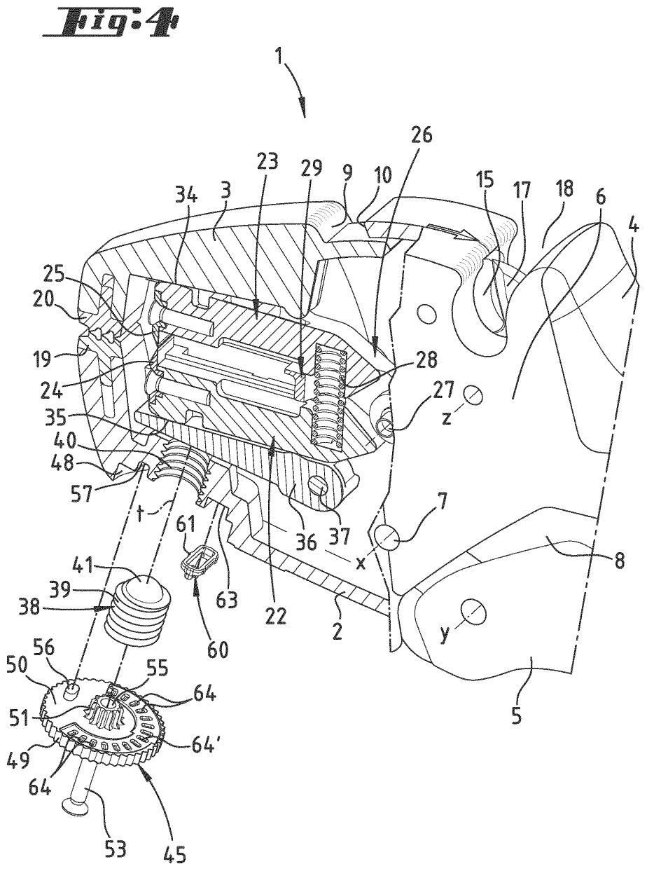

The pliers mouth open position, for example according to the representation in FIG. 2, is stop-limited, due to the support of a projection area 9 of the movable pliers jaw 3 on an associated support surface 10 of the fixed pliers jaw 2.

The further handle part 5 is pivotally mounted about a further geometric axis y aligned parallel to the pivot axis 7 or its geometric axis x. The physical axis concerned is likewise held in the cheek area 6 of the fixed pliers jaw 2 or of the fixed handle part 4.

The movable handle part 5 can be pivoted about the axis y in the direction of the fixed handle part 4, wherein a pivoting displacement of the movable handle part 5 towards the fixed handle part 4 causes a coupled rotational movement of the movable pliers jaw 3 about the axis x.

For this purpose, a control lever 11 is fastened to the movable handle part 5, which with its free end acts indirectly on a cantilever 13 of the shoulder area 8 of the movable pliers jaw 3.

The control lever 11 is held pivotably on the movable handle part 5. The pivot axis concerned preferably runs parallel to the geometric pivot axis x.

A return spring 14, preferably in the form of a leg spring, acts between the control lever 11 and the movable handle part 5. This biases the movable handle part 5 towards the basic position of the wire stripping pliers shown in FIG. 2.

In addition, the movable handle part 5 acts via a link 16 on a blade 17 pivotally mounted in the cheek area 6 of the fixed pliers jaw 2. The blade 17 is mounted in the cheek area 6. The geometric axis z concerned also runs parallel to the geometric pivot axis x of the movable pliers jaw 3.

The blade 17 lies exposed in a cut-out area 18 of the fixed pliers jaw 3 or of the cheek area 6 and preferably serves to cut a cable to length, for example a cable to be stripped in a further step.

The blade 17 can interact with a fixed counter-blade 15 fastened to the pliers jaw 3.

By the pivoting movement of the blade 17 in the course of pivoting the movable handle part 5 towards the fixed handle part 4, a cable possibly lying in the area 18 is cut by the pivoted blade 17 while supported on the flanks of the cheek area 6, which delimit the area 18, and/or while in contact with the counter-blade 15.

The two pliers jaws 2 and 3 each have an outer clamping jaw 19 and 20 for clamping a free end of a cable 21 inserted into the pliers mouth ZM for stripping, compare FIGS. 9 to 14.

In addition, two inner cutting jaws 22 and 23 are provided, with respect to the arrangement of the clamping jaws 19 and 20 relative to the geometric pivot axis x, each with blades 24 and 25 fixed in the end region facing the clamping jaws 19 and 20. The blades 24 and 25 are arranged with their cutting edges 32 and 33 facing one another.

The cutting jaws 22 and 23 are combined into a pair of cutting jaws 26 and are connected to one another at the ends facing away from the blades 24 and 25 via a pivot axis 27, which pivot axis 27 allows the cutting jaws 22 and 23 to pivot relative to one another.

In the operational arrangement of the pair of cutting jaws 26, the geometric axis of the pivot axis 27 extends preferably parallel to the pivot axis x of the movable pliers jaw 3.

A spring 28, for example in the form of a cylindrical compression spring, is arranged between the cutting jaws 22 and 23, which spring 28 biases the cutting jaws 22 and 23 into a mutually spaced open position according to FIG. 2.

In the embodiment shown, a stop carriage 29, which can be locked in place in the direction of extension of the cutting jaw 22, is provided on the lower cutting jaw 22 to offer a stop for the free end of the cable 21 inserted into the pliers mouth ZM, thereby reproducibly defining the length of the area to be stripped.

The cutting jaws 22 and 23 are guided laterally in the respective pliers jaw 2, 3 to enable proper sliding displacement of the cutting jaws 22 and 23 in the direction of their longitudinal extension, i.e. starting from a position spaced apart from the clamping jaws 19 and 20 into an end position displaced towards the pivot axis x and from this end position back into the starting position.

A pull rod 30 is provided for this displacement of the cutting jaws 22 and 23, preferably of the pair of cutting jaws 26 as a whole.

The control lever 11 is articulated at its free end to an end region of the pull rod 30 so that a pivoting actuation of the movable handle part 5 can act on the pull rod 30 and thereby on the pair of cutting jaws 26.

The pull rod 30 is supported (initially and essentially in the basic position of the wire stripping pliers 1) on a bridge section 31 of the movable pliers jaw cantilever 13, so that the cutting jaws 22 and 23, in the course of squeezing the handle parts 4 and 5 against the force of the return spring 14, can be displaced from a starting position into an end position.

The upper cutting jaw 23 lies against a facing sliding surface 33 of the movable pliers jaw 3, along which sliding surface 33 the cutting jaw 23 can slide in supported manner during displacement via the pull rod 30.

The lower cutting jaw 22 also finds such a facing sliding surface 34, but not directly on the facing fixed pliers jaw 2, rather on a sliding shoe 35 provided for this purpose. The sliding shoe 35 is pivotably mounted on the fixed pliers jaw 2 about an axis 37 parallel to the pivot axis x.

The support of the sliding shoe 35 on the fixed pliers jaw 2 is provided by an adjusting screw 38 which is held on the fixed pliers jaw 2 by means of an external thread 39 that engages in a threaded opening 40 of the fixed pliers jaw 2.

The adjusting screw 38 has a domed support section 41 pointing towards the sliding shoe 36. Opposite the support section 41, when viewed in the direction of the rotational axis t of the adjusting screw 38, the adjusting screw 38 is provided with a drive opening 42, for example with a polygonal opening.

The drive opening 42 is suitable for receiving a correspondingly designed tool 52 by means of which adjustment or initial setting of the pair of cutting jaws 26 can be carried out by displacing the adjusting screw 38 along its rotational axis t.

Thus, for example by the manufacturer, but also optionally within normal use by the user, a basic position can be set with regard to the distance a between the cutting edges 32 and 33 of the blades 24 and 25. This basic position can be, as indicated for example in FIG. 5, the position of the wire stripping pliers 1 in which the clamping jaws 19 and 20 lie against one another.

From this set basic position, reliable proper stripping of cables 21 of different diameters is achievable in accordance with the specified working range of the wire stripping pliers 1, without the strands 44 to be exposed being damaged by cutting into or cutting through the insulation jacket 43.

The adjusting screw 38 can be connected to an adjusting wheel 45, via which readjustment can be made from the basic position of the adjusting screw 38 if necessary, for example due to unfavorable conditions, such as unfavorable climatic conditions, and/or for small cable diameters.

The adjusting wheel 45 can be inserted into an edge-open recess 48 formed in the fixed pliers jaw 2, wherein preferably in the course of insertion an alignment of the adjusting wheel 45 relative to a marking 46 on the fixed pliers jaw 2 indicating the basic position is made. For this purpose, the adjusting wheel 45 has a counter-marking 47 on an upper side facing away from the adjusting screw 38.

In the area of the recess 48, which is open to the side surfaces of the pliers jaws, the adjusting wheel 45 can be grasped for rotation. The respective edge area of the adjustment wheel 45 can be provided with a knurled surface 49, for example, for improved handling.

The adjusting wheel 45 can be fixed relative to the adjusting screw 38. For this purpose, a positive engagement can first be provided, for which the adjusting wheel 45 has, on its underside 50 facing the adjusting screw 38, a drive projection 51 which centrally receives the rotational axis t, for positive engagement in the drive opening 42 of the adjusting screw 38.

In the course of arranging the adjusting wheel 45 on the adjusting screw 38 and thereby establishing positive engagement, the counter-marking 47 of the adjusting wheel 45 is preferably aligned with the marking 46.

The positive engagement is finally secured by a locking screw 53, which passes through a central bore 55 of the adjusting wheel 45 and engages in a thread 54 of the adjusting screw 38 (see FIG. 7). It may be a screw with a self-locking thread. Alternatively, an adhesive applied to the thread may be used for additional security.

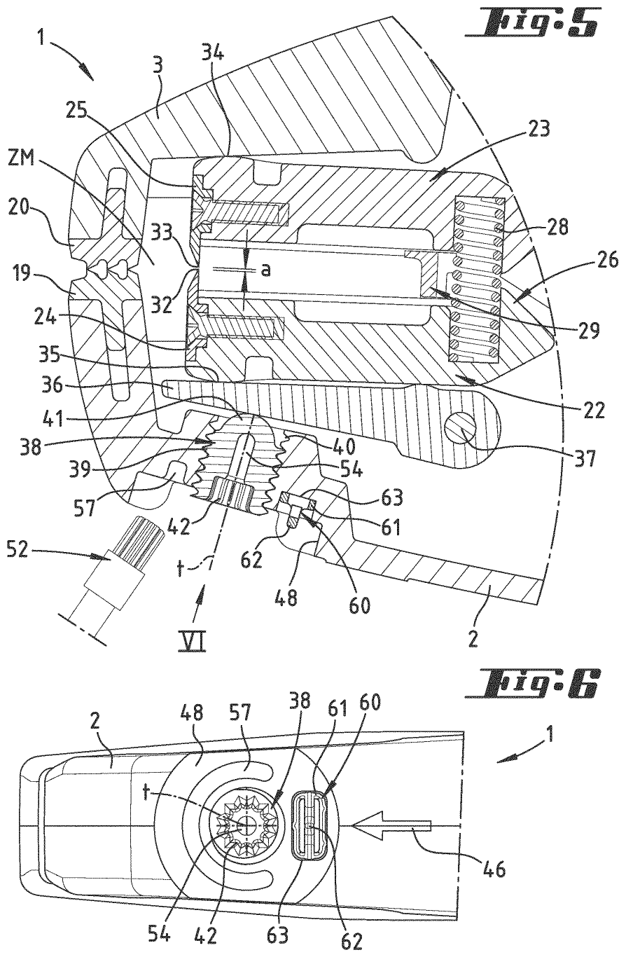

The rotatability of the adjusting wheel 45 and, via it, of the adjusting screw 38 positively connected thereto is limited, in the normal use position of the wire stripping pliers 1, to a predetermined rotation angle range a of, for example, approximately 190 to 200°. For this purpose, the adjusting wheel 45 can have, on its underside 50, a projection 56 which engages in a longitudinally limited groove 57 in the facing surface of the fixed pliers jaw 2 (compare FIGS. 7 and 8).

Starting from the basic position shown for example in FIG. 8, the adjusting device E formed by the adjusting wheel 45 and the adjusting screw 38 can be rotated in both directions of rotation up to the respective rotation stop and thus, for example, in each case by about 100°. As can further be seen, additional markings 58 and 59 can be provided on the upper side next to the counter-marking 47, which indicate a plus rotation direction P and a minus rotation direction M. These markings are intended to indicate to the user, for example, that rotation of the adjusting device E from the basic position in the “minus” direction causes a (further) reduction in the distance a between the cutting edges 32 and 33, whereas rotation of the adjusting device E from the basic position in the “plus” direction causes a (further) increase in this distance a.

By rotation of the adjusting device E from the basic position, a change in the cutting-edge distance a is preferably achievable by linear displacement of the adjusting screw 38 along its rotational axis t in the range from 1/100 millimeters up to a few 1/10 millimeters. Such linear displacement of the adjusting screw 38 is accompanied by a corresponding angular alignment of the sliding shoe 36, due to its support on the adjusting screw 38, and thus by a corresponding orientation of the sliding surface 35 for the lower cutting jaw 22.

The adjusting wheel 45 and thus the entire adjusting device E can be detented in several circumferential positions, in particular in the basic position in which the jaw-side marking 46 and the counter-marking 47 of the adjusting wheel 45 coincide.

A detent device 60 can be provided which interacts with the adjusting wheel 45 in different rotation angle positions. The detent device 60 can be a plastic element comprising a base 61 and a detent projection 62 attached to the base 61, which is set to be resiliently deflectable essentially in alignment with the rotational axis t of the adjusting device E.

In the detent device 60, which is received and held in a depression 63 provided at the bottom side in the area of the recess 48 of the fixed pliers jaw 2, the entire part can be an injection-molded component made of an elastically resilient plastic.

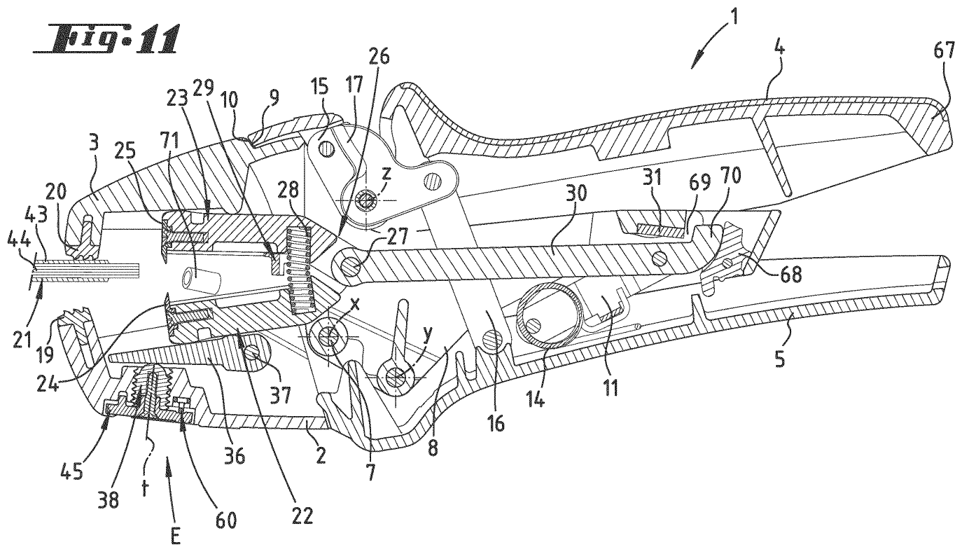

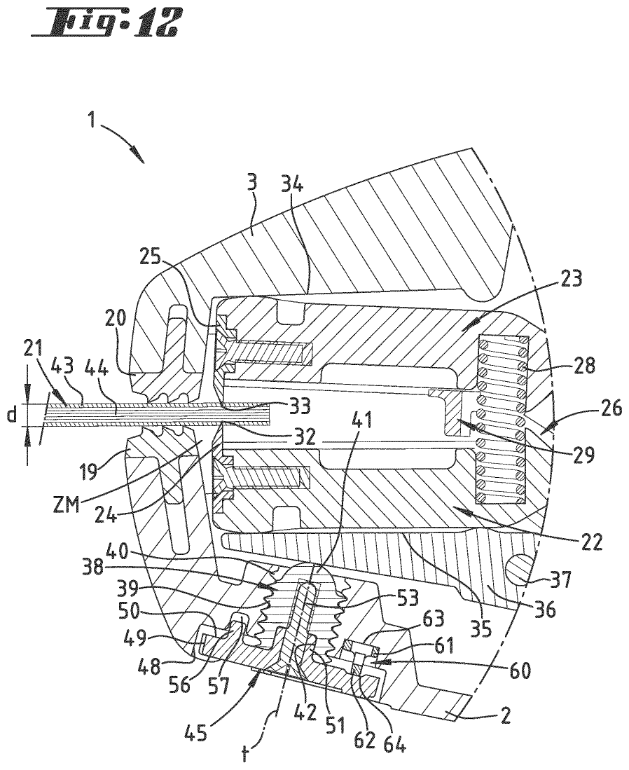

The detent projection 62 of the detent device 60 interacts with detent recesses 64 formed on the underside 50 of the adjusting wheel 45. As can be seen from FIGS. 15 and 17, the adjusting wheel 45 may have fifteen detent recesses 64 evenly spaced from one another in the circumferential direction, with a central detent recess 64′, viewed in the circumferential direction, being assigned to the alignment of the adjusting wheel in the basic position.

The detent recesses 64 are initially and essentially identical in design, in particular with regard to their ground plans, in which the rotational axis t appears as a point, and with regard to their respective depths b, viewed perpendicular to the ground plan extension, between a recess valley 66 and a surrounding recess edge 65.

Furthermore, the detent recesses 64 are formed at different height levels with regard to the positioning of their recess edges 65 and with reference to the overall surrounding surface of the underside 50. With reference to the above-mentioned surface, different distances c to the respective recess edge 65 result when viewed in the direction of the rotational axis t, wherein, starting from a last detent recess 64 viewed circumferentially, this distance c continuously decreases from detent recess 64 to the next detent recess 64 in the circumferential direction or increases in the opposite circumferential direction. Thus, starting from one end of the arrangement of detent recesses, the distance c of the detent recesses 64 to the other end can approximately double or halve, for example from about 0.5 to 2 mm to about 1 to 4 mm.

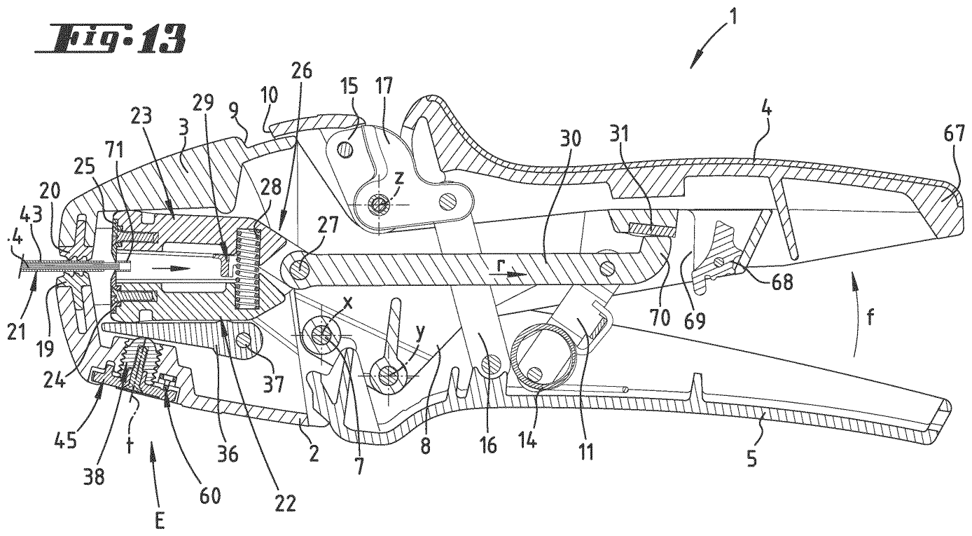

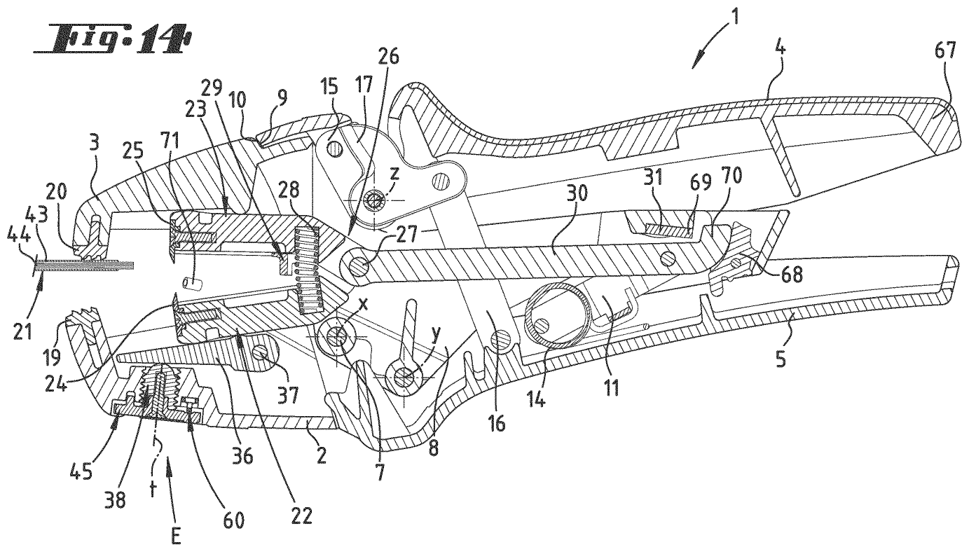

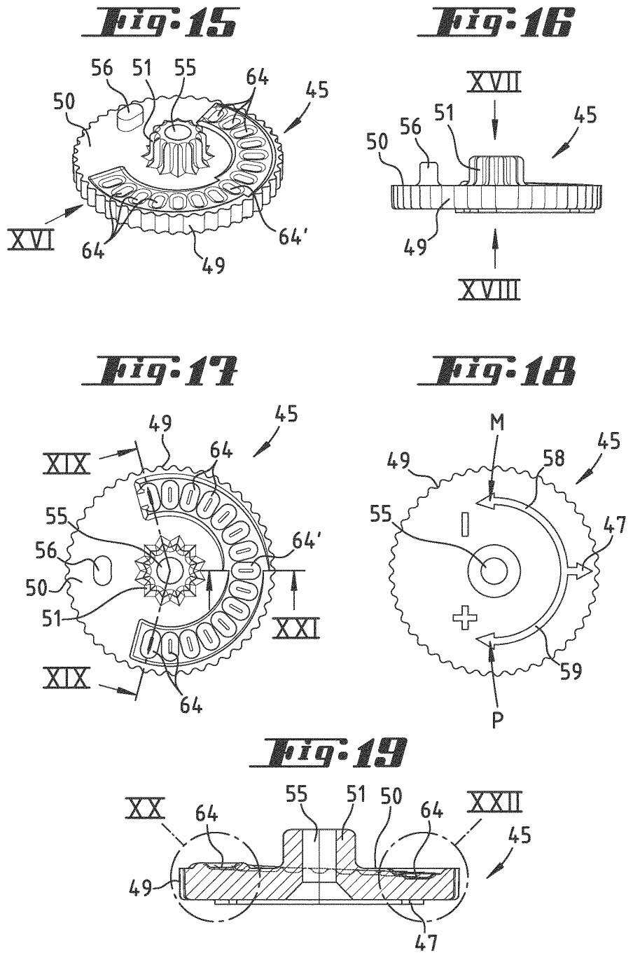

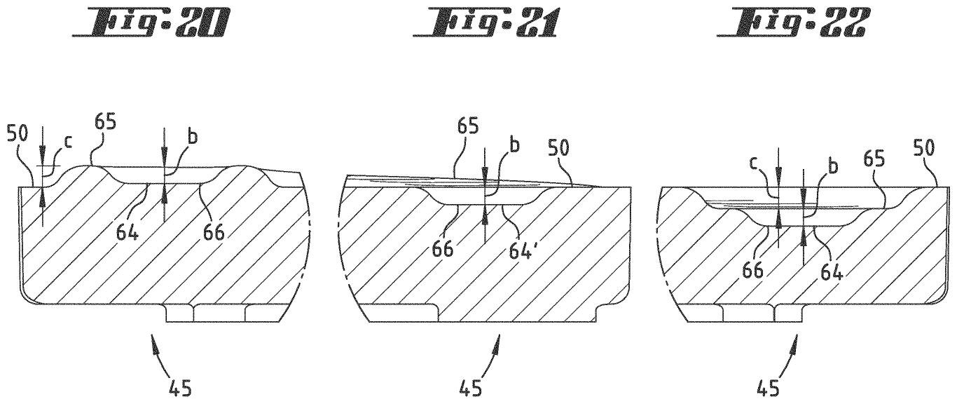

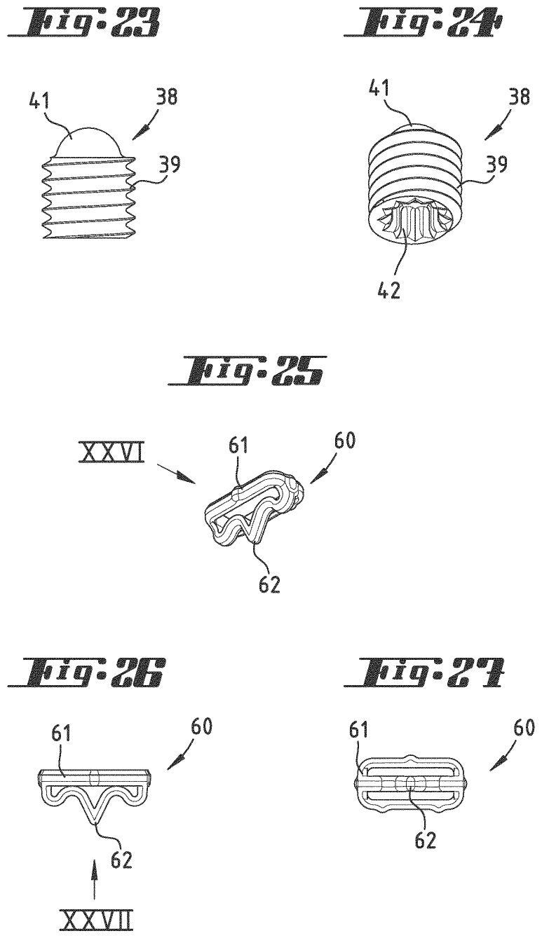

In this case, as preferred, the central detent recess 64′ can lie essentially at the level of the surrounding surface of the underside 50 with regard to its recess edge 65, from which, in the plus rotation direction P, the distance c increases such that an increasing spacing of the recess edge above the underside 50 results. Again starting from the central detent recess 64′, the distance decreases continuously in the minus rotation direction M, resulting in an increasing lowering of the recess edge below the underside 50 (compare FIGS. 19 to 22).

The arrangement of the detent recesses 64 at different (circumferentially increasing or decreasing) height levels gives the user, when operating the adjusting device E, a haptic signal of increasing or decreasing spring force that must be overcome to override a detent position.

In an alternative embodiment, the adjusting wheel 45 may be non-destructively non-removably connected to the adjusting screw 38, so that after a, for example factory, setting of the basic position, the user is no longer allowed access solely to the adjusting screw 38 that defines the basic setting. Only fine adjustment via the adjusting wheel 45 is possible thereafter.

With reference to FIGS. 9 to 14, the basic function of the wire stripping pliers 1 is described essentially below. FIGS. 9 to 11 show the function in the course of stripping a cable 21 with a comparatively large diameter d, and FIGS. 12 to 14 show the function with a cable 21 of a comparatively small diameter d.

Depending on the total diameter d of the cable 21, there also results, essentially in a fixed ratio, the thickness in the diameter direction of the insulation jacket 43 to be cut or pierced.

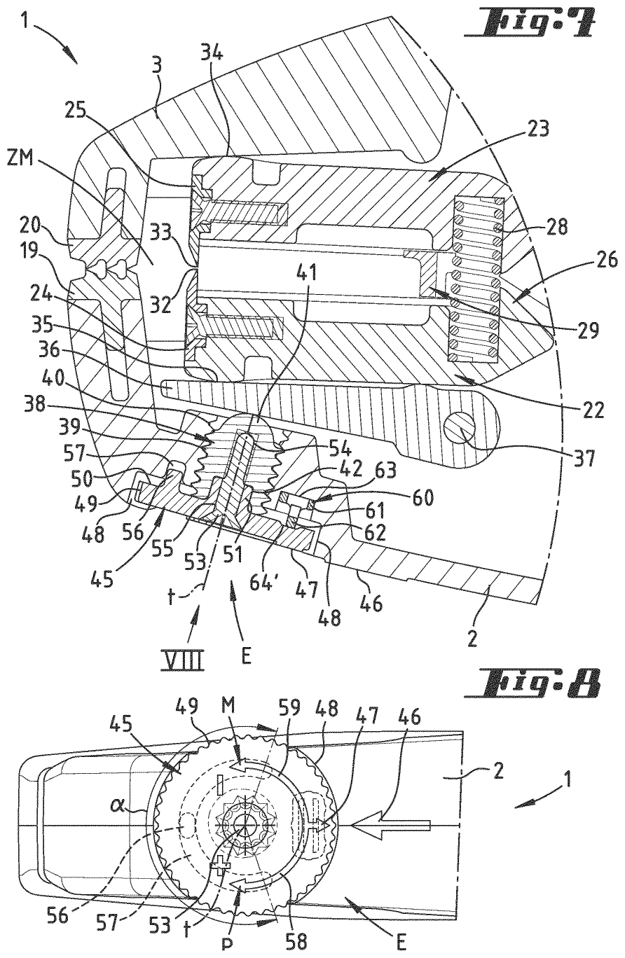

With pivoting displacement of the movable handle part 5 about its axis y towards the fixed handle part 4 (see pivot direction f, e.g., in FIG. 10), the control lever 11 acts on the pull rod 30. The pull rod 30 thereby initially supports itself via an application end 70 on the bridge section 31 of the jaw-side cantilever 13, so that correspondingly the movable handle part 5 indirectly acts pivotingly on the cantilever 13 and the jaw 3 rigidly connected thereto. This leads to a closure of the pliers mouth ZM into a clamping position in which the clamping jaws 19 and 20 grip the cable 21.

Via the sliding surfaces 34 and 35 of the pliers jaw 3 and of the sliding shoe 36, the cutting jaws 22 and 23 are pivoted about their pivot axis 27 to the same extent in the course of the pliers-jaw pivoting displacement, so that in the clamping position according to FIG. 9 or also according to FIG. 12, the blades 24 and 25 cut into the insulation jacket 43 without damaging the strands 44 to be exposed.

Depending on the course of the cutting edges 32 and 33 in the circumferential direction of the cable 21, cutting can be carried out essentially completely circumferentially. With straight cutting edges 32 and 33, as used in the described embodiment, each cutting edge 32 and 33 can also make a secant-like cut, whereby initially essentially diametrically opposing tear-off webs can remain.

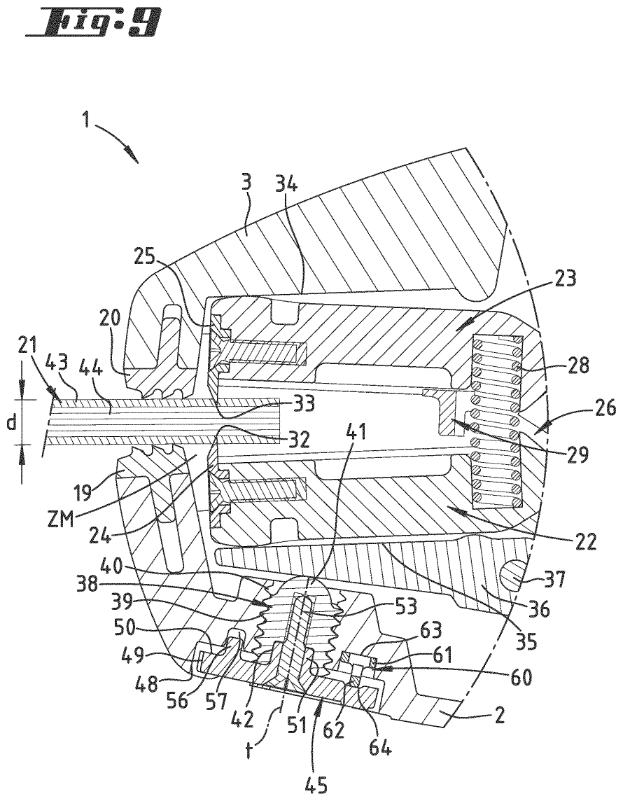

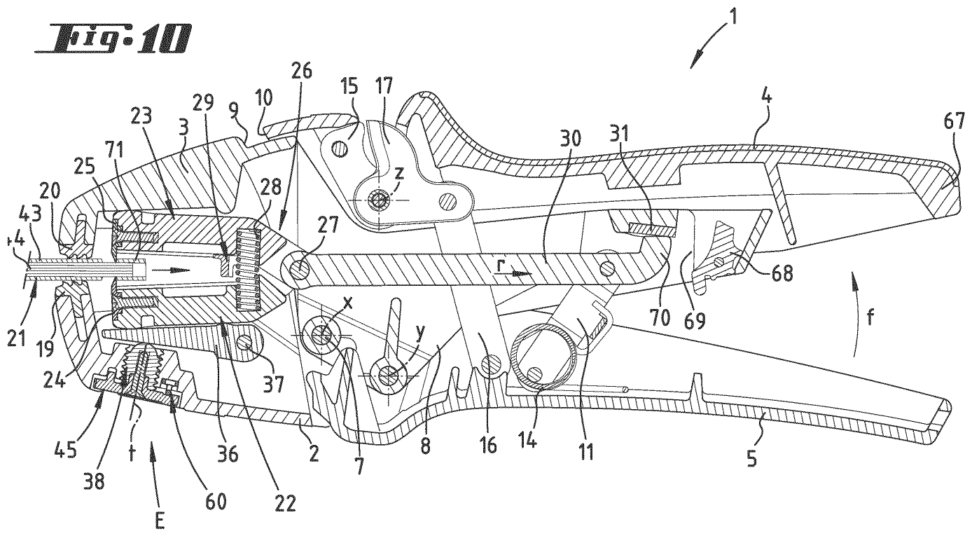

In the cable clamping position according to FIG. 9 or 12, further pivoting displacement of the movable pliers jaw 3 and thus of the pair of cutting jaws 26 towards a pliers-mouth closed position is prevented. This leads to the effect that, in the course of further actuation of the movable handle part 5 and the associated further pivoting of the same (pivot direction f) beyond this clamping position, the pull rod 30, which continues to be acted upon via the control lever 11, first slides along the bridge section 31 in direction r towards a free end 67 of the fixed handle part 4 (compare FIG. 10 or FIG. 13), into an end position in which the pull rod 30 loses support on the bridge section 31 and, with its application end 70, falls into a free space 69 remaining in direction r between the bridge section 31 and an adjacent control section 68, which is likewise rigidly formed on the cantilever 13 (compare FIG. 11 or FIG. 14).

As a result of the associated further displacement of the pull rod 30 in direction r, the pair of cutting jaws 26 is also displaced linearly while maintaining the cut-in position, so that, possibly under tearing off of tear-off webs remaining in the course of cutting, the end section 71 of the insulation jacket 43 is pulled off the conductor or the strands 44 and thus the conductor is exposed.

Upon reaching the overrun position, in which the pull rod 30 loses support on the cantilever-side bridge section 31, a pivot return of the cutting jaws 22 and 23 and, via them, in particular of the movable pliers jaw 3 towards the starting position occurs due to the restoring force of the spring 28, previously tensioned in the course of the closing operation between the cutting jaws 22 and 23. The pliers mouth ZM opens, the cable 21 with the stripped end is released, and the severed and pulled-off section 71 of the insulation jacket 43 is discarded.

With removal of the actuation force on the movable handle part 5, this returns due to the restoring force of the return spring 14 towards the basic position, dragging along the pull rod 30 via the control lever 11, wherein due to sliding of the pull-rod-side application end 70 on the control section 68, the pull rod 30 receives an impulse for linear return displacement counter to the arrow direction r. The pair of cutting jaws 26 is thereby displaced back into the starting position, for example according to FIG. 2.

### LIST OF REFERENCE SYMBOLS

| | | | |
|---|---|---|---|
| 1 | wire stripping pliers | 2 | fixed pliers jaw |
| 3 | movable pliers jaw | 4 | fixed handle |
| 5 | movable handle | 6 | cheek area |
| 7 | pivot axis | 8 | shoulder area |
| 9 | projection area | 10 | support surface |
| 11 | control lever | 13 | cantilever |
| 14 | return spring | 15 | counter-blade |
| 16 | link | 17 | blade |
| 18 | area | 19 | clamping jaw |
| 20 | clamping jaw | 21 | cable |
| 22 | cutting jaw | 23 | cutting jaw |
| 24 | blade | 25 | blade |
| 26 | pair of cutting jaws | 27 | pivot axis |
| 28 | spring | 29 | stop carriage |
| 30 | pull rod | 31 | bridge section |
| 32 | cutting edge | 33 | cutting edge |
| 34 | sliding surface | 35 | sliding surface |
| 36 | sliding shoe | 37 | axis |
| 38 | adjusting screw | 39 | external thread |
| 40 | threaded opening | 41 | support section |
| 42 | drive opening | 43 | insulation jacket |
| 44 | strand | 45 | adjusting wheel |
| 46 | marking | 47 | counter-marking |
| 48 | recess | 49 | knurling |
| 50 | underside | 51 | drive projection |
| 52 | tool | 53 | locking screw |
| 54 | thread | 55 | bore |
| 56 | projection | 57 | groove |
| 58 | marking | 59 | marking |
| 60 | detent device | 61 | base |
| 62 | detent projection | 63 | depression |
| 64 | detent recess | 64′ | detent recess |
| 65 | recess edge | 66 | recess valley |
| 67 | free end | 68 | control section |
| 69 | free space | 70 | application end |
| 71 | section | | |
| a | distance | b | depth |
| c | distance | d | diameter |
| f | pivot direction | r | direction |
| t | rotational axis | x | axis |
| y | axis | z | axis |
| | | E | adjusting device |
| M | minus rotation direction | P | plus rotation direction |
| ZM | pliers mouth; | | |
| α | angle | | |

1. A wire stripping pliers (1) comprising two pliers jaws (2, 3), two outer clamping jaws (19, 20), two inner cutting jaws (22, 23), and two handle parts (4, 5), wherein the cutting jaws (22, 23) are displaceable from a starting position into an end position in the course of squeezing the handle parts (4, 5), and wherein the cutting jaws (22, 23) each have a blade (24, 25) with a cutting edge (32, 33), the cutting edges (32, 33), in a defined position in which the cutting jaws (22, 23) are brought towards one another, being at a specific distance (a) from each other, and wherein, in a position to be regarded as a basic position, the distance (a) is adjustable via an adjusting screw (38), wherein the adjusting screw (38) is connected to an adjusting wheel (45) which is configured to be aligned with a marking (46) fixed to one of the pliers jaws (2, 3) for the basic position, wherein a fixing of the position of the adjusting wheel (45) relative to the adjusting screw (38) is made unchangeably, the fixing being achieved by a locking screw (53) which passes through the adjusting wheel (45) and is received in a thread (54) of the adjusting screw (38), or by a positive engagement of the adjusting wheel (45) with the adjusting screw (38), wherein a receptacle of the adjusting screw has a polygonal cross-section for receiving a polygonal drive projection of the adjusting wheel (45), and wherein the positive engagement is finally secured by a locking screw (53) which passes through a central bore of the adjusting wheel (45) and engages in a thread (54) of the adjusting screw (38).

2-4. (canceled)

5. The wire stripping pliers according to claim 1, wherein the adjusting wheel (45) interacts with a detent device (60) fixed to the pliers jaw (2, 3).

6. The wire stripping pliers according to claim 5, wherein the detent device (60) has a projecting, resilient detent projection (62) which engages in a detent recess (64, 64′) of the adjusting wheel (45).

7. The wire stripping pliers according to claim 6, wherein, viewed in a direction of rotation (P/M) of the adjusting wheel (45), a plurality of detent recesses (64, 64′) are formed and the detent recesses (64, 64′) are formed at different height levels with respect to the direction of rotation (P/M).

8. The wire stripping pliers according to claim 1, wherein, for limiting a rotatability of the adjusting wheel (45), a limitation to a specific rotation angle range (a) is provided.

9. The wire stripping pliers according to claim 8, wherein the rotation angle range (a) is less than 360°.

10. The wire stripping pliers according to claim 8, wherein the limitation of the rotatability of the adjusting wheel (45) is achieved by a projection (56) formed on an underside (50) of the adjusting wheel (45), which engages in a longitudinally limited groove (57) in the pliers jaw (2, 3).

11. The wire stripping pliers according to claim 1, wherein one or both cutting jaws (22, 23), in a direction of travel of the cutting jaws (22, 23) relative to one another, are acted upon on an outside of the cutting jaw (22, 23) by a sliding shoe (36).

12. The wire stripping pliers according to claim 11, wherein the adjusting screw (38) acts on the sliding shoe (36).

13. A method for setting a cutting-edge spacing on wire stripping pliers having two pliers jaws (2, 3), two outer clamping jaws (19, 20), two inner cutting jaws (22, 23), and two handle parts (4, 5), wherein the cutting jaws (22, 23) are displaceable from a starting position into an end position in the course of squeezing the handle parts (4, 5), and wherein the cutting jaws (22, 23) each have a blade (24, 25) with a cutting edge (32, 33), wherein the cutting edges (32, 33), in a defined position in which the cutting jaws (22, 23) are brought towards one another, are at a specific distance (a) from each other, and wherein the method comprises: in a position defined as a basic position, adjusting the distance (a) via an adjusting screw (38), wherein the adjusting screw (38) is connectable to the adjusting wheel (45) and the adjusting wheel (45) can be aligned with a marking fixed to one of the pliers jaws (2, 3) for the basic position, so that for setting the basic setting, only the adjusting screw (38) is used, and only after this basic alignment of the cutting jaws (22, 23) the adjusting screw (38) is provided with the adjusting wheel (45) to enable a further distance adjustment to be carried out from the basic position.
